(19) United States
(12) Patent Application Publication
(10) Pub. No.: US 2011/0184773 A1
(43) Pub. Date: Jul. 28, 2011

(54) Method and System for Planning Paratransit Runs

(75) Inventors: Keith W. FORSTALL, Lexington, MA (US); Jan BEDNARZ, Dernancourt (AU); Moru NUHAMOVICI, Thornhill (CA)

(73) Assignee: TRAPEZE SOFTWARE INC., Mississauga (CA)

(21) Appl. No.: 12/975,680

(22) Filed: Dec. 22, 2010

Related U.S. Application Data
(60) Provisional application No. 61/291,000, filed on Dec. 30, 2009.
(60) Provisional application No. 61/291,007, filed on Dec. 30, 2009.

(51) Int. Cl. G06Q 10/00

(52) U.S. Cl. 705/7.25

(57) ABSTRACT

A method and system for paratransit run-cutting are provided. Expected demand is determined over a set of time intervals for a time period from historical demand data stored in a database. A supply of vehicles required to meet a desired level of the expected demand over each of the time intervals during the time period is estimated. At least partial runs are blocked together from the supply estimated, during the estimating, for each of the time intervals during the time period according to a set of rules.

This application claims priority from U.S. Provisional Patent Application Ser. Nos. 61/291,000 and 61/291,007, both filed on Dec. 30, 2009, the contents of which are incorporated herein by reference.

### FIELD OF THE INVENTION

The present invention relates generally to paratransit. More particularly, the present invention relates to a method and system for planning paratransit runs.

### BACKGROUND OF THE INVENTION

Traditional public transit provisioning is known. A set of fixed routes is established for a metropolitan area being served. For each fixed route, there is a physical route being travelled by public transit vehicles, including the scheduled stops along the physical route, as well as a time schedule for when a transit vehicle is expected to be at a particular scheduled stop. The fixed routes are established based on the population distribution and the street layout of the metropolitan area, as well as the perceived demand.

Various systems have been developed to solve the problems that public transit organizations face in providing fixed-route service. Such problems include the revision of physical routes, the adjustment of the frequency of service along the fixed routes, etc.

Paratransit, or dial-a-ride, is an alternative mode of flexible on-demand passenger transportation that does not follow fixed routes or schedules. Typically vans or mini-buses are used to provide paratransit service, but share taxis and jitneys can also be used. Paratransit services operated by public transit organizations are often fully demand-responsive transport, wherein on-demand call-up door-to-door service from any origin to any destination in a service area is offered. Such services are typically provided to serve people in the metropolitan area that are physically-challenged, who are provided transportation services in accordance with an insurance program of some type, etc.

While, with fixed-route public transit, a level of service is determined to meet the needs of the majority of the people using the service, the goals differ for the level of service provided to paratransit users. It is generally desirable to ensure that users requesting service receive service.

If the volume of passengers for fixed-route transit exceeds the expected volume for a particular day, typically such excess volume is readily accommodated by often-less-than-full public transit vehicles. As the volume of passengers for most fixed routes is relatively large, variations in the volume of passengers in a fixed-route transit system generally are relatively insignificant. As the volume of passengers in a paratransit system is generally quite small, variations in the volume of passengers, and the trips they take, in both locations and durations, can be quite significant.

Further, during periods of lower volume, fixed-route transit service still provides a relatively-significant level of service due to the low cost of providing the service. In contrast, paratransit, because of the accommodating, customized nature of the service, tends to have a much higher associated cost for public transit operators. As a result, it is desirable to reduce slack in providing such service while not significantly affecting the level of service provided.

It is therefore an object of the invention to provide a novel method and system for planning paratransit service.

### SUMMARY OF THE INVENTION

According to an aspect of the invention, there is provided a method for paratransit run-cutting, comprising:
determining, via a processor, expected demand over a set of time intervals for a time period from historical demand data stored in a database;
estimating a supply of vehicles required to meet a desired level of said expected demand over each of said time intervals during said time period; and
blocking together at least partial runs from said supply estimated, during said estimating, for each of said time intervals during said time period according to a set of rules.

The method can further include: coupling at least some of said at least partial runs that are less than a desired length.

The coupling can be performed until the portion of the at least partial runs, either alone or in combination, that are at least equal to the desired length satisfies a specified minimum

The method can further include: determining the productivity for said vehicles for said time intervals.

The determining can be performed for each vehicle type of the vehicles.

The determining can include: analyzing the productivity for said vehicles using historical data.

The estimating can include: adjusting the productivity to account for periods of slack time identified in said historical data.

The estimating can further include: adjusting the productivity to account for late passenger pick-ups.

The determining can include: grouping weekdays together.

The method can further include: receiving said time period from a user via an input interface.

The determining the expected demand can include: adjusting demand during said time period from said historical data for growth.

An initial value for the expected demand can be determined for the time intervals from the historical data by dividing the number of pick-ups and drop-offs occurring during the time intervals by two.

The desired level can correspond to the portion of time that all demand is expected to be satisfied.

According to another aspect of the invention, there is provided a system for paratransit run-cutting, comprising:
a database stored in non-volatile memory of a server, said historical database storing historical demand data;
a demand analysis tool for estimating expected demand over a set of time intervals for a time period from said historical demand data;
a supply analysis tool for estimating a supply of vehicles required to meet a desired level of said expected demand over each of said time intervals during said time period; and a blocking tool for blocking together at least partial runs from said supply estimated for each of said time intervals during said time period according to a set of rules.

The system can further include: a run-cutting tool for coupling at least some of said at least partial runs that are less than a desired length. The run-cutting tool can couple the at least partial runs until the portion of the at least partial runs, either alone or in combination, that are at least equal to the desired length satisfies a specified minimum.

The system can further include: a productivity analysis tool for determining the productivity for said vehicles for said time intervals. The productivity analysis tool can determine the productivity for each vehicle type of the vehicles.

The productivity analysis tool can adjust the productivity of the vehicles to account for periods of slack time, or for late passenger pick-ups, identified in the historical data.

The demand analysis tool can group weekdays together.

The demand analysis tool can adjust demand during the time period from the historical data for growth.

The desired level can correspond to the portion of time that all demand is expected to be satisfied.

### BRIEF DESCRIPTION OF THE DRAWINGS

Embodiments will now be described, by way of example only, with reference to the attached Figures, wherein:

FIG. 1 shows a schematic representation of a system for paratransit run-cutting in accordance with an embodiment of the invention;

FIG. 2 is a flowchart of the general method for planning paratransit runs using the system of FIG. 1; and

FIG. 3 is a table of legal run types defined by the paratransit operator.

### DETAILED DESCRIPTION OF THE EMBODIMENTS

The paratransit run-planning (or “run-cutting”) solution is markedly different than fixed-route transit solutions to account for the significant differences between the nature of fixed-route service and paratransit demand-response service with respect to the way in which supply responds to demand. These differences include the fact that demand response services tend to vary by day of the week rather than being fairly constant throughout the five business days in a week. Also, fixed-route service is based on defining the runs needed to deliver a succession of fixed-route trips at a designated frequency (headway) along a fixed route and passing various time-points and bus stops, whereas demand response service must provide enough aggregate capacity to meet a somewhat random set of pick-up and drop-off times and addresses. While it may be acceptable to not have planned fixed-route service that can handle the requirements of a particular passenger, the very nature of paratransit leads to a high desirability to meet demand in almost every case.

The approach developed to address paratransit run-cutting is to analyze historical paratransit ridership information to identify trends and patterns of demand and estimate the number of runs required by time interval on each day of the week. Given the cost of providing paratransit, it is desirable to estimate the expected demand accurately. Further, it has been found that by analyzing the demand as it changes during various time intervals of the day and during various days and times of year, a more granular estimate of expected demand can be generated. The amount of supply required to satisfy that expected demand is then determined for the various time intervals. Supply corresponds to the number (and type) of vehicles required to satisfy the demand. Based on the demand and supply analysis, runs to serve the estimated demand are proposed, given various constraints. The runs are then assembled, or “cut”, into pieces of work that drivers can bid on or can then be assigned.

While the term “run-cutting” is used to describe the overall process of generating runs that are biddable or can be assigned, the term is later used to describe the particular steps of assembling blocks of time into runs. It is believed that it will be sufficiently clear when the overall process or the particular steps are being referred to.

Paratransit is currently generally over-provisioned to ensure that all demand is met almost all of the time. This is evidenced by metrics of both passengers per total vehicle hours and passengers per revenue vehicle hour for most paratransit services. In many cases, the “pay-to-platform” ratio, corresponding to the amount of time a vehicle operator is paid versus the amount of time the vehicle operator is actually serving customers, is often as high as 1.6. A goal of the paratransit run-cutting solution developed is to assist in better understanding demand and how to best serve it, whilst potentially reducing the amount of time that vehicle operators are idle/not serving customers (i.e., reducing the pay-to-platform ratio). For private operators, any cost savings achieved directly impact the bottom line. For public operators, better understanding how to serve demand for paratransit can translate into the ability to handle growth in demand without pro rata increased costs.

The solution developed uses statistical analysis to evaluate fluctuations in demand over time to project an appropriate amount of service to meet a user-determined level of service availability (measured, for example, by the number of service denials that the user is willing to tolerate). The output of the analysis is expressed as a number of runs of designated capacity type by time of day and day of week. Capacity types are predefined by the user based on the vehicle fleet available, expressed as a maximum number of available vehicles in each of one or more categories of seating configurations. Seating configurations may include one or more optional configurations. For example, a capacity type might include a configuration of four seats and no wheelchairs or two seats and one wheelchair. The analysis takes into consideration the existence of group travel (either many riders from one destination to another destination or many riders from many origins to one destination or many riders from one origin to many destinations), to ensure that the runs that are created take into consideration both the availability constraints of the existing vehicles and also the efficiency considerations of putting members of a group trip together on a single run wherever possible. The origins (i.e., pick-up locations) and/or destinations (i.e., drop-off locations) for trips can be analyzed to identify patterns associated with such groups, as well as the number of wheelchair users, the average direct distance between the origins and the destinations, and the demand per square mile per hour.

The paratransit run-cutting solution also takes into consideration labor or other constraints that are expressed in the form of certain guidelines such as the maximum number of split runs (runs that are significantly shorter than a typical eight-hour shift for a vehicle operator), or runs of a designated amount of time, or maximum and minimum time lengths of runs.

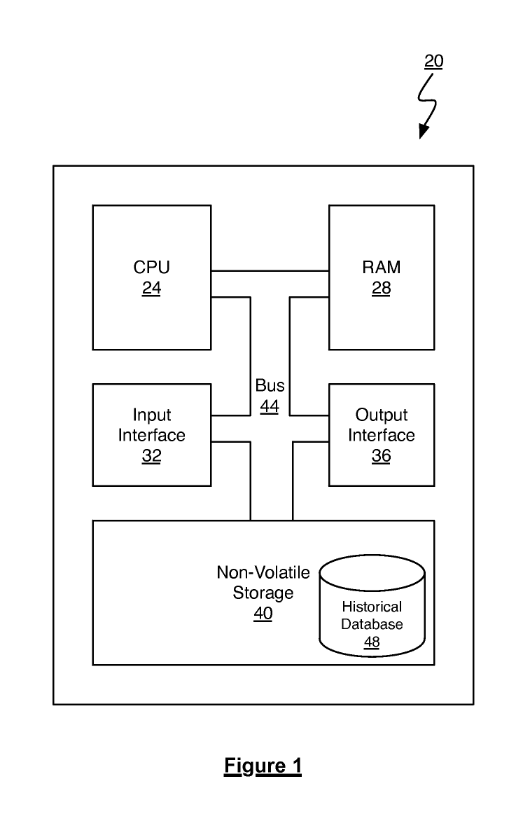

FIG. 1 shows a system 20 for paratransit run-cutting in accordance with an embodiment of the invention. The system 20 includes one or more servers that cooperatively provide the functionality required. Where there is more than one server, the servers can be in communication with one another over a local area network, or can be distributed remotely and in communication with each other via one or more communication networks, including, for example, the Internet. In the embodiment described herein, the system 20 consists of one server.

As shown, the system 20 has a number of components, including a central processing unit (“CPU”) 24, random access memory (“RAM”) 28, an input interface 32, an output interface 36 non-volatile storage 40, a network interface 44 and a local bus 48 enabling the CPU 24 to communicate with the other components. The CPU 24 executes an operating system and programs that provide the desired functionality. RAM 28 provides relatively responsive volatile storage to the CPU 24. The input interface 32 allows for input to be received from one or more devices, such as a keyboard, a mouse, etc. The output interface 36 enables the CPU 24 to present output to a user via a monitor, a speaker, etc. Non-volatile storage 40 stores the operating system and programs, as well as data used by both. The network interface 48 permits communication with other systems for obtaining demand or productivity data, communicating results, etc.

A historical database 52 is maintained by the server in non-volatile storage 40. The historical database 52 is a registry for past demand for the paratransit service. The historical database 52 stores historical trip and run information, including the number of customer events (pick-ups and drop-offs) by time period.

The system 20 executes software for paratransit run-cutting that is stored in the non-volatile storage 40. The paratransit run-cutting software includes a number of components and services. In particular, the paratransit run-cutting software includes a demand analysis tool, a productivity analysis tool, a supply estimation tool, a blocking tool and a run-cutting tool. The demand analysis tool produces a demand profile by time of day and day of week upon which supply requirements are based. The productivity analysis tool estimates the achievable productivity profile by time of day by type of vehicle. The supply estimation tool essentially divides the demand for each time interval by the productivity to estimate the required number of vehicles by time of day and day of week. The blocking tool builds runs that best fit the supply requirements for each time interval in order to reduce the amount of excess capacity while observing certain constraints such as maximum percent split runs and maximum spread time per run. The run-cutting tool then assembles the resulting paratransit runs into rostered biddable/assignable pieces of work.

The paratransit run-cutting software is a Core3 browser-based application that provides an interface that allows the user to set parameters and constraints, launch the demand, productivity, supply, blocking, and run-cutting tools, review the results, and edit the recommended runs as necessary. In addition, the user interface allows acceptance and export of the final results into one or more paratransit scheduling solutions so that the new run-cut can be deployed into a production or test scheduling environment.

The user interface itself includes a logon screen for restricting access to authorized personnel. A properties screen enables specification of the location of the historical database 52 to be queried for the demand, productivity and supply (hereinafter referred to interchangeably as “demand/supply”) analysis. The properties screen also allows the user to specify the date range to be included in the demand/supply analysis. Separate dialogs permit the user to launch the demand analysis tool, the productivity analysis tool and the supply estimation tool. These three steps can also be performed using a wizard approach that walks a user through the process. Another dialog enables the user to specify the blocking and run-cutting parameters and launch these two tools.

A further dialog allows the user to update a standard paratransit scheduling application with the paratransit run-cut information that is created. This is accomplished via the Simple Object Access Protocol (“SOAP”) application programming interface (“API”).

The user interface allows the user to specify the available supply in terms such as the available capacity type configurations and the maximum concurrent number of runs of each capacity type that can be supplied. In addition, the paratransit run-planning software includes a web server to enable interaction with the various components via a graphical interface.

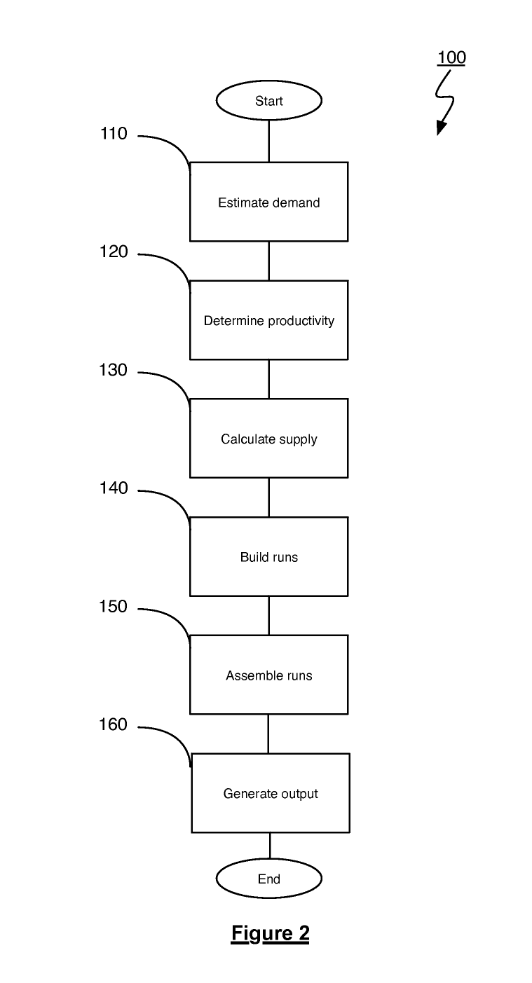

The general method for paratransit run-cutting using the system 20 is shown generally at 100 in FIG. 2.

### Demand Analysis

The method 100 commences with the estimation of expected demand (step 110).

In order to estimate expected demand and productivity, common time intervals are established to permit their analysis as they change during the day/week/month/year. In addition, other inputs that are common to the demand/supply analysis are obtained. The user interface allows a user to define the data to be used for the analysis, including the source of the data and any boundaries such as date range to be applied as a filter in selecting data for the analysis. In addition, the user interface also allows the user to specify the available supply in terms such as the available capacity type configurations and the maximum concurrent number of runs that can be supplied of each capacity type.

The demand, productivity, and supply analysis all work on a common definition of the date range and time intervals to be used for the analysis. Therefore, a single screen is used to define the following for all three stages of the demand, productivity and supply analysis:

From Date, To Date, and Exception Dates: A calendar style selection is used so that the user can click on the from date, shift-click on the to date, and control-click on all exception dates (holidays or other days that the user wishes to exclude due to extraordinary circumstances such as snow days when service is cancelled). Selected dates are highlighted in color.
Time period: A slide bar allows selection of the time increment size used for the analysis, with available settings of ¼ hour, ½ hour, or a whole hour.
Group all weekdays together: A checkbox enables a user to group all weekdays together. If checked, all weekdays are treated equally, with demand being estimated using all weekdays. By default, this box is unchecked, thus treating each weekday separately.
Demand determination basis: This is a set of radio buttons to enable the selection of requested time, scheduled time, or estimated time to be used as a basis for categorizing trips into time increments.
Trip categorization: This is a set of checkboxes that allows inclusion of no-show trips, cancelled trips, and/or unscheduled trips in the analysis. Additional checkboxes enable the inclusion or exclusion of trips by subtype. This is useful if, for example, denied and refused trips are categorized by subtype.
External providers: There is a set of checkboxes to enable inclusion or exclusion of trips on taxi runs and to include or exclude specific providers (trips scheduled on or stamped with specific provider IDs).
Estimated growth rate: This field permits a user to override the annual growth rate for demand determined by the demand analysis.

The demand analysis tool treats each day of the week separately. Alternatively, if specified by the user, each weekday is treated the same, and Saturday and Sunday are treated separately. As many paratransit operators have patterns of usage that vary by weekday (Wednesdays are often busier than other weekdays, for example), it can be desirable to perform the analysis treating each day of the week separately. The selection inputs also allow the user to identify exception days (e.g. holidays) that should be excluded from the analysis.

The times of both pick-ups and drop-offs are considered when computing demand. Trip counts are attributed to a time interval based on the sum of all pick-ups and drop-offs, divided by two. This helps to properly recognize the commitments at the end of each run when all pick-ups have been completed but the run is still busy with drop-offs.

The demand analysis tool looks at scheduled trips. The user might or might not want to include certain other trips. The system supports the ability to include or exclude trips of certain user-defined subtypes. It also supports the inclusion or exclusion of canceled or unscheduled trips. Unscheduled trips are trips that cannot be satisfied and are therefore unscheduled. Although these trips may not be serviced, the requests can be recorded to enable measurement of unsatisfied demand. For unscheduled trips, the request time is used and the average trip length is used to project a time for the non-request end of each trip.

Users are able to limit the analysis to trips scheduled on, or stamped with, specific providers. This is useful both for complex sites like PACE as well as for sites that routinely throw off a portion of their demand to taxis. Users are also able to run the analysis exclusively on cancelled trips, if so desired. If a time-based pattern of cancellations can be observed, it can allow users to design the availability of service not on the scheduled demand, but on the net demand after foreseeable cancellations have been factored in.

The total demand by time interval is then summed for each day type and divided by the number of qualifying days in the period to arrive at an average demand by time interval by day type.

During operation, a paratransit operator can, for example, select to process demand by month. The demand analysis tool examines the demand over the specified period (i.e., month in this case) from the previous year in order to estimate the demand for the same month this year.

Selection of the date range over which to analyze demand is important to the success of the process. Paratransit is often seasonal in nature. Therefore, a good way to look at expected demand for a pending summer season, for example, is to look at demand for the same period of time in the prior year, and then adjust demand for the amount of growth over the last year. The system 20 permits users to allow the demand analysis tool to calculate this growth rate based on a specific date range or on the data for the entire year. Alternatively, users can enter in a rate of growth to adjust last year's demand by to arrive at an expected demand.

The demand analysis tool analyzes not only the average demand by time interval (i.e., quarter-hour, half-hour, whole hour, etc.) but also computes standard deviations. This provides an understanding not only of the averages but of the frequency with which these averages are likely to be exceeded by any given amount. For paratransit operators that have no ability either to deny service or to absorb the extra demand on “heavy days” by farming trips off to undedicated taxi operators, this information is relevant because they may need to design not to the average but e.g. to two standard deviations above the average.

The demand analysis tool generates as output a table of demand by time period/day type (e.g., “9:00-9:14 Monday” or “10:00-10:59 weekday”) and a graphical view of the results. The graphical display shows, for example, the average demand for all Mondays in the selected date range and the demand for the busiest Monday sampled, if requested to do so.

The output of the demand analysis tool is capable of calling the user's attention to patterns such as the first Wednesday of the month is always the heaviest. This is true for many U.S. metropolitan areas as government checks distributed on this day are immediately used by retirees to go shopping. As such, this output is a useful end product in its own right and helps planners to forecast which days of the month they should be prepared to handle the highest demand.

In paratransit, group trips often constitute a significant part of the overall demand and stress on paratransit operators at peak times. In some cities, operators have had success lobbying group centers to make minor alterations in program times to help improve transportation. Therefore, to support such efforts, output of the analysis that shows how such time shifts could distribute demand in ways that would lead to a better run cut are a valuable part of the product.

### Productivity Analysis

Once the expected demand has been estimated, the productivity of the paratransit vehicles is estimated (step 120). This is performed by the productivity analysis tool.

It can be challenging to generate a viable productivity model. As a result, where historical productivity data is available, it can be desirable to use the current productivity as a starting point for the productivity analysis.

The following inputs are obtained for the various vehicle types:
Available capacity types: This refers mainly to wheelchair/seat configurations. Capacity types are predefined by the user based on the vehicle fleet available, expressed as a maximum number of available vehicles in each of one or more categories of seating configurations. Seating configurations may include one or more optional configurations. For example, a capacity type might include a configuration of four seats and no wheelchairs or two seats and one wheelchair.
Number of vehicles of each type
Minimum spare ratio (or else express the number of vehicles net of spares). This represents the ratio of vehicles that, at a minimum, may be expected to be unavailable for providing service at any time. For example, vehicles may undergo regular maintenance and may, thus, be unavailable for providing service. Further, an estimated irregular maintenance rate may be used to estimate how many further vehicles may become unavailable for providing service. Alternatively, maybe a peak pullout number (enhanced later by capacity type) may be provided.

The current productivity for each vehicle type is taken at face value as an initial single value for each time interval. The total number of client events (pick-ups and drop-offs) is divided by two to obtain the number of passengers/trips during the time interval, then divided by the total number of vehicle hours in the time interval to arrive at a value for passengers/trips per vehicle hour in that time interval.

Existing productivity understates optimal productivity to the extent that there are shortcomings in existing run-cuts as well as in the operation generally. To the extent that measured productivity falls short of achievable productivity because of inherent management problems, a better run-cut is not going to fix the inherent problems and so “theoretically attainable” productivity is not meaningful. However, to the extent that current productivity is sub-optimal because a poor run-cut provides inadequate resources in certain times and leaves excess slack capacity at other times, the current productivity understate what is attainable.

That said, a productivity number is calculated for each time interval by taking the current total number of vehicles and adjusting it as follows. First, any vehicle that is slack for a specified block of time that at least partially overlaps the time interval is removed from the count. The specified period of time during which a vehicle is slack before it is removed from the count is set by default to a value of 60 or 90 minutes. Next, one or more additional runs is added, if required, to compensate for late pick-ups. That is, a number of runs can be added to the count based on a formula which takes into consideration the number/percent of existing runs that operated late by more than a user-specified number of minutes during that time interval. For example, if 20% of the runs have at least one pick-up that is later than the SchedLate time by more than 15 minutes, add 10% more vehicle hours. The SchedLate time is the end-time for the window during which a vehicle is scheduled to arrive. This formula is sufficiently parameterized to allow empirical testing to find the correct sensitivity.

Based on the above adjustments, an adjusted target productivity is computed by dividing the resulting number of vehicle hours into the total passenger count for the period.

In some situations, vehicle capacity is considered in determining achievable productivity. This occurs with paratransit operators that transport large groups whose size exceeds the capacity of the largest vehicles. It also occurs at sites with large concentrations of wheelchair riders and limited vehicles that can handle more than one or two wheelchairs. For these situations, capacity constraints are factored into the productivity analysis.

In order to determine productivity, the following inputs are obtained by the productivity analysis tool: the specified minimum size of slack-time blocks to be deducted when computing adjusted productivity, and the threshold number of minutes late an existing run must be to trigger the assumption that the current number of runs is inadequate.

The productivity analysis tool generates a productivity factor for each type of vehicle by day type and time interval.

### Supply Estimation

Using the productivity of the paratransit vehicles determined during the productivity analysis at step 120, the supply required to meet the estimated expected demand is calculated (step 130). This is performed by the supply estimation tool. The supply analysis uses the demand and productivity analysis results to predict the optimum number of runs of varying pre-defined capacity vehicle types by time interval and day. The supply requirements throughout the day using this approach is illustrated graphically by drawing a graph which shows supply superimposed on demand, by hour, with the two vertical scales factored by productivity, and the “ideal” supply profile would superimpose directly on top of the demand line.

The supply estimate tool looks at fluctuations in the number of trips by time interval of the day. It can be desirable to have the control to use quarter hour time periods for the purpose of defining when run pull-outs and pull-ins occur. At the same time, when looking at demand in quarter hour increments, some “smoothing” is beneficial because of the tendency for the majority of trip requests to be either on the hour or half hour.

Aggregate demand numbers are translated into supply requirements based on predicted productivity levels. In each day/time interval, the estimated demand (trips) is divided by the estimated productivity (trips/vehicle hour) to arrive at an estimated number of vehicles (runs), or initial supply estimate required to meet the demand. The actual number of vehicles flagged to satisfy demand depends on the types of vehicles as some can carry more passengers of different types than others.

The initial supply estimate is adjusted according to the user preference to meet certain service level standards. In particular, users can specify a desired probability of satisfying demand, expressed as the percent of total number of service denials that the operator is willing to tolerate over a one month period, etc. Statistical analysis is used to evaluate fluctuations in demand over time to project an optimum amount of service to meet the user-determined level of service availability. The output of this stage of the analysis is expressed as a number of runs of designated capacity type by time interval and day of week.

Alternatively, the user can specify the maximum amount of demand that they are capable of outsourcing, and have the product base its projections on meeting 100% of the remaining demand on the worst day.

The supply estimation tool generates output corresponding to the number of runs of the various vehicle types required by time interval and day type. The output is available in both tabular and graphical formats.

### Run-Blocking

Once the supply required to meet the demand is determined, runs are blocked together in accordance with the supply by the blocking tool (step 150).

The run-cutting algorithm takes the results of the supply estimate tool (that is, the estimates of the number of runs required by time interval and day) and uses them to produce runs (blocks). The blocking algorithm takes into consideration the following constraints.
The number of runs on the road at any time of the day should cover some or all of the projected demand all or most of the time, as stipulated by the paratransit operator.
The number of runs on the road at any time of day cannot exceed the maximum pullout capability of the available fleet. The operator may remove this limitation in order to understand when to add vehicles to the fleet. In fact, parameters for new vehicle types not yet operated by the paratransit operator can be entered to determined if any should be bought where demand is high. In this case, the new vehicle type is assigned a lower priority than other currently-operated vehicle types.
The maximum number of runs that can be scheduled to pull out in any one time interval.
The operator can specify the maximum number of total service hours (pull-out to pull-in). This can pose an insoluble problem, given the demand. It is common practice, however, particularly among sites that have the ability to divert demand to taxis or other undedicated resources. The goal in such a case can be to satisfy as much demand as possible given the maximum available hours, thus minimizing the number/cost of trips that must be diverted, as the cost of these is generally picked up by the paratransit operators.
The operator can specify various parameters that define different types of legal runs. The different types of legal runs form profiles. All runs are then constructed to conform to one of the profiles defined for a legal run. This is expressed as a minimum run time and a maximum run time.
Runs either qualify as full time “straight” assignments or as candidates to be matched with other part-time “split” runs according to rules that qualify for full-time split shift rules. The operator can specify the maximum percent of runs that are split candidates.

The blocking tool obtains a number of inputs from the user, including the types of runs that the operator wishes to schedule. The user can define any number of distinct run types. For each distinct run type, the user can specify the minimum run time and the maximum run time.

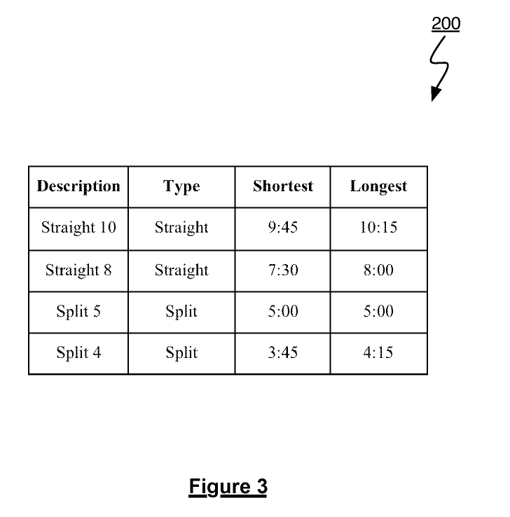

FIG. 3 illustrates a legal run type table 200 of four distinct run types defined by an operator. The first legal run type, labeled “Straight 10”, is a straight run of minimum length 9 h45 m and maximum length 10 h 15 m. The second legal run type, labeled “Straight 8”, is a straight run of minimum length 7 h 30 m and maximum length 8 h 00 m. The third legal run type, labeled “Split 5”, is a split run of five hours in length. The fourth legal run type, labeled “Split 4”, is a split run of minimum length 3 h 45 m and maximum length 4 h 15 m.

Users can also specify the amount of time to assume as non-revenue from the pullout to the first available pick-up, as well as from the last drop-off to the pull-in. This will need to be added to every run.

The process of blocking runs involves carving out as many straight runs as possible, and then meeting the rest of the demand through the use of split-type runs.

In order to meet the constraints of a legal run as specified by the operator, in some cases, additional time is appended onto runs. For example, if a run length of 6 h 30 m is calculated to meet demand, it can be desirable to append 1.5 hours on an end of the run to make it a standard straight eight hour run. For this purpose, every time period is evaluated for its “risk factor”, which is a rough measure of variance. The risk factor for a particular period is, in the default configuration, measured by taking the maximum demand for the particular period on any qualifying date and dividing it by the average demand for the particular period across all qualifying days. In other words, the risk factor is a measure of the likelihood that demand will exceed the amount on which the run requirements are defined, and therefore the likelihood that having an additional run available will be useful. As extra runs are added for a particular time period through the time-appending process for runs, this risk factor is diluted for that time period and other time periods become relatively more critical.

User inputs permit the time allowance for a formal lunch break policy, if so desired.

The outputs of the run-block analysis are as follows:
A tabular representation of runs, including start time and end time.
A graphical representation of runs, including start time and end time. Each run is color-coded to show what type of run it is.
A tabular summary of the solution, showing the number of runs of each defined type.
A series of metrics that represent the efficiency of the solution. This includes the pay-to-platform ratio, assuming a user-defined deadhead on the pull-out and pull-in of each run.

### Run-Cutting

Runs are then assembled into biddable/assignable pieces of work by the run-cutting tool (step 150).

Using the above parameters and the aggregate supply requirements produced by the demand/supply analysis, a run-cut algorithm uses logic to produce a paratransit run-cut. The run-cut consists of recommended biddable pieces of work. In traditional scenarios, each piece of work consists of either a single straight run or two split runs. The information for each run includes the start time and end time for each day of the week.

The inputs obtained at this stage are:
the minimum percent of straight runs (which is equal to the maximum percent of split runs)
which split types can be combined; for example, can a piece of work be made up of two “Split 5” runs?
the maximum spread time allowed, measured from the first run pull-in to the second run pull-out and/or measured from the first run pull-out to the second run pull-in
the maximum number or percent of split runs that can be created as part time runs, meaning they are not combined with any other run to make a full-time driver piece of work.

The run-cut algorithm uses the results of the blocking algorithm to generate biddable/assignable pieces of work, or a “run-cut”. The run-cut consists of recommended runs, including, for each recommended run, the start time, end time, and capacity type, for each day of the week.

Once the runs are assembled at step 150, output is generated (step 160). The user interface permits review of the run-cut results and approval thereof. The SOAP API permits interfacing directly with the paratransit run-cutting software to access the paratransit run-cutting software results via a commercial transit scheduling system once the nm-cut has been reviewed and approved. In addition, the paratransit run-planning software also generates a set of runs in both graphical and tabular format that can be used for manually establishing runs in another system, if so desired.

Once output is generated, the method 100 ends. The method 100 can be then used to perform run-cuts for other periods of the year, to test other scenarios, etc.

While the invention has been described with specificity to a certain approach, those of skill in the art will appreciate that variations to the approach described above can be used without departing from the spirit of the invention. For example, productivity can alternatively be determined using service parameters to estimate achievable productivity where there is little or no historical data. There are several key determinants of achievable productivity:
percent group trips (transporting a group of people from a single origin to a single destination)
percent group many-to-one (MTO) trips
percent wheelchair trips
demand density (trip requests per square mile per hour)
average passenger trip length
allowable trip denial rate

These numbers are unique to any paratransit operator, and are the ones that would be used if we were to try to build a predictive model of achievable productivity. While some of them may be relatively constant across time for a particular site, others may vary considerably throughout the day. The ones that vary most by time of day are worth representing at a more granular level of detail in order to get a better estimate of hourly productivity variations and therefore hourly supply requirements.

The two variables that can be desirable using this approach are:
percent of trips that are either group or group MTO—Identify periods of time when group and group MTO trips occur, and compute a separate productivity number for these periods.
demand density (measured in trips per square mile per hour)—allow the user to define “low density” time periods, or alternatively, the system can determine these periods. To determine the low-density periods, the total pick-ups per hour can be calculated for each hourly period, and the bottom 25% or so ranked hours can be classified as low density. The productivity during those low-density hours can then be computed. It can be desirable that hourly periods be used for this purpose regardless of the periods used elsewhere in the analysis, since using too small a time period may produce unreasonable results. For example, if quarter hour periods are used, the period that includes the top of the hour may tend to have the majority of the trips, even in the off-peak, whereas some of the other time periods may be taken as off-peak times even in the busiest time of the day.

Using this approach, supply requirements can be computed by hour based on productivity estimates adjusted for whether the time period is a “normal” time period, a “group service” time period, or a “low-density” time period.

While the term “tool” is used in the description above, those skilled in the art will appreciate that any combination of software, firmware and/or hardware that provides the required functionality fall within the scope of the term.

The above-described embodiments are intended to be examples of the present invention and alterations and modifications may be effected thereto, by those of skill in the art, without departing from the scope of the invention that is defined solely by the claims appended hereto.

What is claimed is:

1. A method for paratransit run-cutting, comprising:
determining, via a processor, expected demand over a set of time intervals for a time period from historical demand data stored in a database;
estimating a supply of vehicles required to meet a desired level of said expected demand over each of said time intervals during said time period; and
blocking together at least partial runs from said supply estimated, during said estimating, for each of said time intervals during said time period according to a set of rules.

2. The method of claim 1, further comprising:
coupling at least some of said at least partial runs that are less than a desired length.

3. The method of claim 1, wherein said coupling is performed until the portion of said at least partial runs, either alone or in combination, that are at least equal to said desired length satisfies a specified minimum.

4. The method of claim 1, further comprising:
determining the productivity for said vehicles for said time intervals.

5. The method of claim 4, wherein said determining is performed for each vehicle type of said vehicles.

6. The method of claim 4, wherein said determining comprises:
analyzing the productivity for said vehicles using historical data.

7. The method of claim 4, wherein said estimating comprises:
adjusting the productivity to account for periods of slack time identified in said historical data.

8. The method of claim 7, wherein said estimating further comprises:
adjusting the productivity to account for late passenger pick-ups.

9. The method of claim 1, wherein said determining comprises:
grouping weekdays together.

10. The method of claim 1, further comprising:
receiving said time period from a user via an input interface.

11. The method of claim 1, wherein said determining said expected demand comprises:
adjusting demand during said time period from said historical data for growth.

12. The method of claim 1, wherein an initial value for said expected demand is determined for said time intervals from said historical data by dividing the number of pick-ups and drop-offs occurring during said time intervals by two.

13. The method of claim 1, wherein said desired level corresponds to the portion of time that all demand is expected to be satisfied.

14. A system for paratransit run-cutting, comprising:
a database stored in non-volatile memory of a server, said historical database storing historical demand data;
a demand analysis tool for estimating expected demand over a set of time intervals for a time period from said historical demand data;
a supply analysis tool for estimating a supply of vehicles required to meet a desired level of said expected demand over each of said time intervals during said time period; and
a blocking tool for blocking together at least partial runs from said supply estimated for each of said time intervals during said time period according to a set of rules.

15. The system of claim 14, further comprising:
a run-cutting tool for coupling at least some of said at least partial runs that are less than a desired length.

16. The system of claim 15, wherein said run-cutting tool couples said at least partial runs until the portion of said at least partial runs, either alone or in combination, that are at least equal to said desired length satisfies a specified minimum.

17. The system of claim 14, further comprising:
a productivity analysis tool for determining the productivity for said vehicles for said time intervals.

18. The system of claim 17, wherein said productivity analysis tool determines the productivity for each vehicle type of said vehicles.

19. The system of claim 17, wherein said productivity analysis tool adjusts the productivity of said vehicles to account for periods of slack time identified in said historical data.

20. The system of claim 17, wherein said productivity analysis tool adjusts the productivity of said vehicles to account for late passenger pick-ups.

21. The system of claim 14, wherein said demand analysis tool groups weekdays together.

22. The system of claim 14, wherein said demand analysis tool adjusts demand during said time period from said historical data for growth.

23. The system of claim 14, wherein said desired level corresponds to the portion of time that all demand is expected to be satisfied.
